(19) United States
(12) Patent Application Publication
(10) Pub. No.: US 2007/0116302 A1
(43) Pub. Date: May 24, 2007

(54) Method and apparatus for reproducing audio data, recording medium, and method and apparatus for recording audio data

(76) Inventors: Kun Suk Kim, Anyang-si (KR); Jea Yong Yoo, Seongnam-si (KR)

Correspondence Address: HARNESS, DICKEY & PIERCE, P.L.C., P.O. BOX 8910, RESTON, VA, 20195, US

(21) Appl. No.: 11/599,425

(22) Filed: Nov. 15, 2006

Related U.S. Application Data
(60) Provisional application No. 60/737,412, filed on Nov. 17, 2005.

(30) Foreign Application Priority Data
Jul. 26, 2006 (KR) 10-2006-0070202

(51) Int. Cl. H04B 1/00

(52) U.S. Cl. 381/119

(57) ABSTRACT

A method and apparatus for reproducing audio data associated with a recording medium from a recording medium, a recording medium, and a method and apparatus for recording audio data on a recording medium are disclosed. The method of reproducing audio data includes checking a mixing indicator included in management information for managing reproduction of the audio data, the mixing indicator indicates whether mixing is applied to primary audio; and controlling whether to mix the primary audio with secondary and/or interactive audio on the basis of the mixing indicator.

This application claims the benefit of Korean Patent Application No. 10-2006-0070202, filed on Jul. 27, 2006, which is hereby incorporated by reference as if fully set forth herein.

This application claims the benefit of the U.S. Provisional Application No. 60/737,412, filed on Nov. 17, 2005, which is hereby incorporated by reference as if fully set forth herein.

### BACKGROUND OF THE INVENTION

1. Field of the Invention

The present invention relates to a method and apparatus for reproducing audio data associated with a recording medium, a recording medium, and a method and apparatus for recording audio data on a recording medium.

2. Discussion of the Related Art

Optical discs are widely used as recording media for recording a large quantity of data. Among such optical discs, new high density recording media such as a Blu-ray disc (BD) or a high definition digital versatile disc (HD-DVD) are under development, which enable long duration recording and storing of high definition video and audio data.

Currently, the high density recording medium, which is considered to be next generation recording medium technology as a data storing solution that significantly surpasses the existing DVD, is under development along with other digital apparatuses.

An optical recording/reproducing device using a standard related to the high density recording medium is also under development. However, since the standard related to the high density recording medium is not completely established, there is a difficulty in developing the optical recording/reproducing device.

Particularly, since a preferred method for reproducing an external input signal and/or audio data stored in a high density recording medium is not yet known, there is a restriction in the development of the optical recording/reproducing device based on the high density recording medium.

### SUMMARY OF THE INVENTION

Accordingly, the present invention is directed to a method and apparatus for reproducing audio data associated with a recording medium, a recording medium, and a method and apparatus for recording audio data on a recording medium that substantially obviate one or more problems due to limitations and disadvantages of the related art.

An object of the present invention is to control reproduction of an external input signal and/or a variety of audio data provided from a high density recording medium.

Another object of the present invention is to provide a method and apparatus for reproducing audio data on the basis of a mixing indicator which is included in management information for managing reproduction of the audio data and indicates whether mixing is applied to the audio data.

Another object of the present invention is to provide a recording medium having a mixing indicator recorded thereon and a method and apparatus for recording audio data on a recording medium on the basis of a mixing indicator.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method of reproducing audio data, comprises checking a mixing indicator included in management information for managing reproduction of the audio data, the mixing indicator indicates whether mixing is applied to primary audio; and controlling whether to mix the primary audio with secondary and/or interactive audio on the basis of the mixing indicator.

In the present invention, the primary audio may not be mixed with the secondary and/or interactive audio in case that the mixing indicator indicates that the mixing is not applied.

In the present invention, the primary audio unmixed with the secondary and/or interactive may be converted into a digital transmission signal by a digital output unit and the digital transmission signal may be transmitted to a digital analog converter (DAC) and outputted as an analog output signal by the digital analog converter (DAC).

In the present invention, the primary audio may be mixed with the secondary and/or interactive audio in case that the mixing indicator indicates that the mixing is applied.

In the present invention, the primary audio mixed with the secondary and/or interactive audio may be encoded, the encoded primary audio may be converted into a digital transmission signal by a digital output unit, and the digital transmission signal may be transmitted to a digital output unit and converted into an analog output signal by a digital analog converter (DAC) included in the digital output unit.

In the present invention the encoded primary audio may have the same or more number of channels as the primary audio.

In the present invention the controlling may include determining whether to mix the primary audio with the secondary and/or interactive audio in case that the indicator indicates that the mixing is applied.

According to another aspect of the present invention, there is provided an apparatus for reproducing audio data, comprising: a mixer mixing primary audio with secondary and/or interactive audio; and a control unit checking a mixing indicator included in management information for managing reproduction of the audio data and controlling whether to mix the primary audio with the secondary and/or interactive audio on the basis of the mixing indicator, the mixing indicator indicates whether mixing is applied to the primary audio.

In the present invention, the control unit may control the primary audio not to be mixed with the secondary and/or interactive in case that the mixing indicator indicates that the mixing is not applied.

In the present invention, the control unit may control the primary audio to be mixed with the secondary and/or interactive audio in case that the mixing indicator indicates that the mixing is applied.

In the present invention, the control unit may determine whether to mix the primary audio with the secondary and/or interactive audio in case that the mixing indicator indicates that the mixing is applied, and control the mixer on the basis of the determination.

In the present invention, the apparatus further comprise an encoder encoding the primary audio mixed with the secondary and/or interactive audio into an audio bit-stream.

In the present invention, the audio bit-stream may have the same or more number of channels as the primary audio.

In the present invention, the apparatus may further comprise a digital output unit converting an audio bit-stream into a digital transmission signal.

According to another aspect of the present invention, there is provided a recording medium having audio data, comprising: at least one stream file including primary audio; and a mixing indicator indicating whether mixing is applied to the primary audio.

In the present invention, the mixing indicator may indicate that the primary audio is not mixed with secondary and/or interactive audio, or indicate that the primary audio is capable of being mixed with the secondary and/or interactive audio.

In the present invention, the mixing indicator may be included in a playlist file for managing reproduction of the stream file and the mixing indicator may indicate whether the mixing is applied to the playlist file.

In the present invention, the mixing indicator may be included in the playlist file as stream attribute information.

In the present invention, the mixing indicator may be included in a clip information file corresponding to the stream file.

According to another aspect of the present invention, there is provided a method of recording audio data on a recording medium, comprising: recording at least one stream file including primary audio and management information for managing reproduction of the stream file, wherein the management information includes a mixing indicator indicating whether mixing is applied to the primary audio.

In the present invention, the management information including the mixing indicator may be a playlist file for managing reproduction of the stream file.

In the present invention, the management information including the mixing indicator may be a clip information file corresponding to the stream file.

According to another aspect of the present invention, there is provided an apparatus for recording audio data on a recording medium, comprising: a recording unit recording data on the recording medium; and a control unit controlling the recording unit to record at least one stream file including primary audio and management information for managing reproduction of the stream file on the recording medium, wherein the management information includes a mixing indicator indicating whether mixing is applied to the primary audio.

According to another aspect of the present invention, there is provided a method of creating a data structure managing reproduction of audio data, comprising: creating at least one stream file including primary audio; and creating at least one management file for managing reproduction of the stream file, wherein the management file includes a mixing indicator indicating whether mixing is applied to the primary audio.

According to another aspect of the present invention, there is provided an apparatus for creating a data structure managing reproduction of audio data, comprising: a control unit creating at least one stream file including primary audio and creating at least one management file for managing reproduction of the stream file, wherein the management file includes a mixing indicator indicating whether mixing is applied to the primary audio.

According to another aspect of the present invention, there is provided a method of reproducing audio data associated with a recording medium, comprising: downloading at least one management file associated with the recording medium, the management file manages reproduction of at least one stream file including primary audio; creating virtual package including the stream file and the downloaded management file; checking a mixing indicator included in the downloaded management file, the mixing indicator indicates whether mixing is applied to the primary audio; and controlling whether to mix the primary audio with secondary and/or interactive audio on the basis of the mixing indicator.

According to another aspect of the present invention, there is provided an apparatus for reproducing audio data associated with a recording medium, comprising: a storage unit storing downloaded data associated with the recording medium; a control unit downloading at least one management file associated with the recording medium to the storage unit, the management file manages reproduction of at least one stream file including primary audio, the control unit creating virtual package including the stream file and the downloaded management file, the control unit checking a mixing indicator included in the downloaded management file, the mixing indicator indicates whether mixing is applied to the primary audio, and the control unit controlling whether to mix the primary audio with secondary and/or interactive audio on the basis of the mixing indicator.

According to another aspect of the present invention, there is provided a method of reproducing audio data, comprising: checking a mixer bypass indicator included in management information for managing reproduction of the audio data, the mixer bypass indictor indicates whether a mixer for secondary and/or interactive audio is bypassed, and controlling whether to bypass the mixer on the basis of the mixer bypass indicator.

According to another aspect of the present invention, there is provided a recording medium having audio data, comprising: at least one stream file including primary audio; and at least one management file for managing reproduction of the stream file, the management file includes a mixer bypass indicator indicating whether a mixer for secondary and/or interactive audio is bypassed.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a conceptual view showing an example of using an optical recording/reproducing device 10 and peripherals, for better understanding of the present invention;

FIG. 2 is a view showing an embodiment of a file structure of data recorded in a recording medium according to the present invention;

FIG. 3 is a view showing a data recording structure recorded in an optical disc;

FIG. 4 is a view showing the configuration of an embodiment of the optical recording/reproducing device 10 according to the present invention;

FIG. 5 is a schematic conceptual view showing an audio mixing model for better understanding audio mixing according to the present invention;

FIGS. 6a to 6c are views showing embodiments of management information including an audio mixing indicator according to the present invention;

FIGS. 7a and 7b are views showing an embodiment of reproduction of audio data according to the present invention; and

FIGS. 8a and 8b are views showing another embodiment of reproduction of audio data according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

Hereinafter, for convenience of description and better understanding of the present invention, an optical disc, such as a BD, will hereinafter be exemplarily used as a recording medium in the present invention. It should be noted that technical ideas of the present invention are applicable to other recording mediums including a HD-DVD without departing from the scope and spirit of the invention.

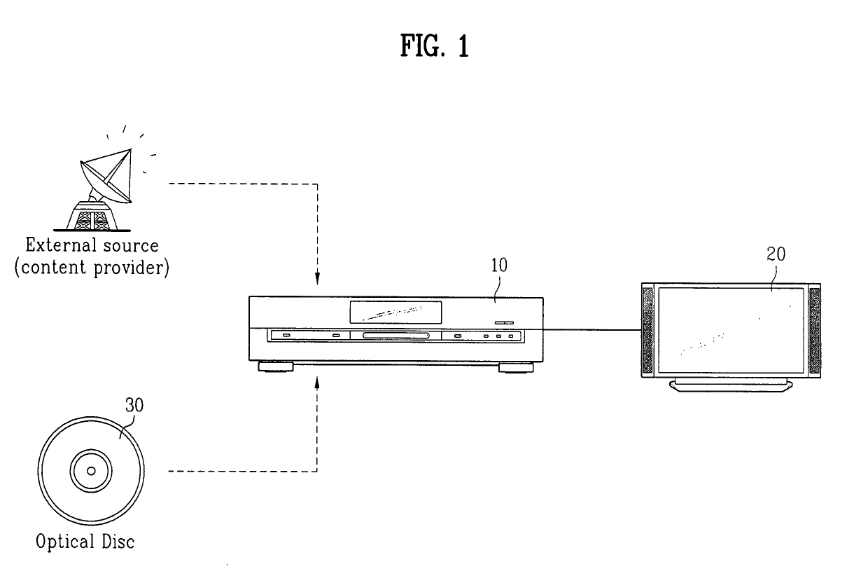

In the present invention, the term “local storage” is indicative of storage means included in an optical recording/reproducing device (FIG. 1), in which necessary information and data is optionally stored and used by a user. The local storage, which is now generally used, includes a hard disc, a system memory, a flash memory, and so on, but the present invention is not limited thereto.

Particularly, in the present invention, the “local storage” is also used as means for storing data associated with the recording medium (e.g., the BD), and the data associated with the recording medium and stored in the local storage is generally data which is externally downloaded.

It is apparent that an allowed portion of data is directly read from the recording medium or system data (e.g., metadata) associated with recording and reproduction of the recording medium is generated and stored in the local storage.

For convenience of description, the data recorded in the recording medium is called “original data” and the data associated with the recording medium of the data stored in the local storage is called “additional data”.

In the present invention, the term “title” is indicative of a reproduction unit interfacing with a user, and each title is linked to a specific object, such that a stream associated with a corresponding title recorded in a disc is reproduced according to a command or a program stored in the object. Particularly, for convenience of description, among titles in which high-definition moving image information according to an MPEG compression scheme is recorded in the disc, a title which supports continuous multi-angle, multi-story, language credit, and director's cut is called an “HDMV title”. Among the titles in which the high definition moving image information according to an MPEG compression scheme is recorded, a title in which Java program information for supporting update of the title in the recording medium and connectivity with a network to allow interactivity is recorded is called “BD-J title”.

In the present invention, the title is also indicative of an indexing item which is included in an index table. That is, a “first playback” having information on a screen which is first reproduced when the recording medium is loaded and a “top menu” for providing a menu screen also belong to the title. The reproduction unit interfacing with the user belongs to the title of the present invention, regardless of the name thereof.

FIG. 1 is a conceptual view showing an example of using an optical recording/reproducing device 10 and peripherals for better understanding of the present invention.

The optical recording/reproducing device 10 can record/reproduce data in/from a variety of optical discs. The optical recording/reproducing device 10 may record/reproduce data in/from only a specific optical disc such as a BD, or can reproduce the data from the optical disc without recording the data on the same. It should be noted that the present invention uses a BD-player capable of reproducing data from a BD and a BD-recorder capable of recording/reproducing data in/from a BD in consideration of connectivity between the BD and the peripherals, which will be realized by the present invention. It is well known in the art that the optical recording/reproducing device 10 is also applicable to a drive embedded in a specific device such as a computer.

The optical recording/reproducing device 10 has a function for receiving and processing an external input signal such that a user can view the processed result on a screen of an external display 20 as well as a function for recording/reproducing data in/from an optical disc 30. In this case, the external input signal may include, but is not limited to, signals acquired from digital multimedia broadcasting or the Internet. Particularly, the Internet is a medium which can be easily accessed by everyone and used for downloading specific data thereon via the optical recording/reproducing device 10.

A person who provides contents as an external source is called a content provider (CP).

The contents are indicative of contents for configuring the title, that is, data provided by an author of a recoding medium a provider thereof.

The original data and the additional data will now be described in detail. For example, when a multiplexed audio and video (AV) stream for a specific title is recorded as the original data recorded in the optical disc and an audio stream (e.g., English) different from an audio stream (e.g., Korean) of the original data is provided as the additional data on the Internet. A user may want to download the audio stream (e.g., English) which is the additional data on the Internet and to reproduce the additional data and the AV stream of the original data or only the additional data. Accordingly, a method for defining connectivity between the original data and the additional data and managing and reproducing these data according to the requirement of the user is required.

For convenience of description, although the signal recorded in the disc is called the original data and the signal recorded on the outside of the disc is called the additional data, the original data and the additional data are only defined according to a method for acquiring the data, and not necessarily limited to specific data. Accordingly, the additional data may include, but is not limited to, an audio, a presentation graphic (PG), an interactive graphic (IG), a text subtitle or a multiplexed AV stream including all the above-mentioned data and a video. Data recorded on the outside of the optical disc and having an attribute associated with the original data may be used as the additional data.

The additional data may be downloaded by an index file, a playlist file (*.m2ts), a clip information (clip-info) file (*.clpi), or the unit of contents or the title.

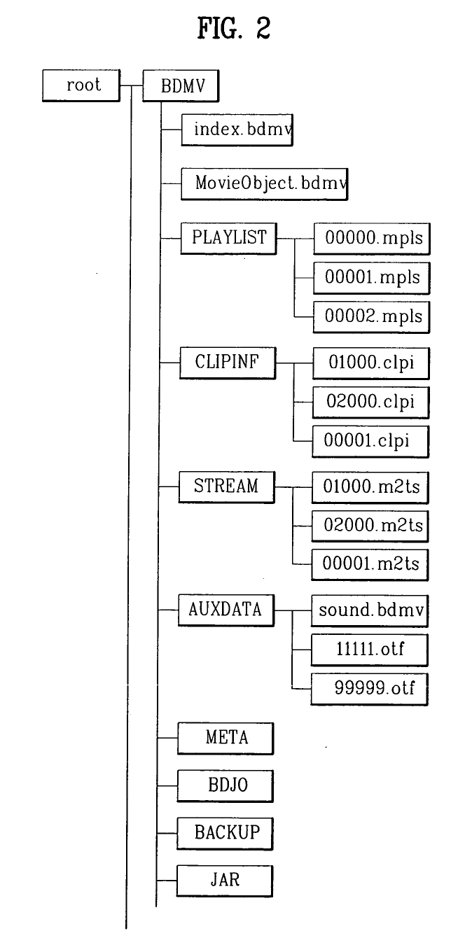

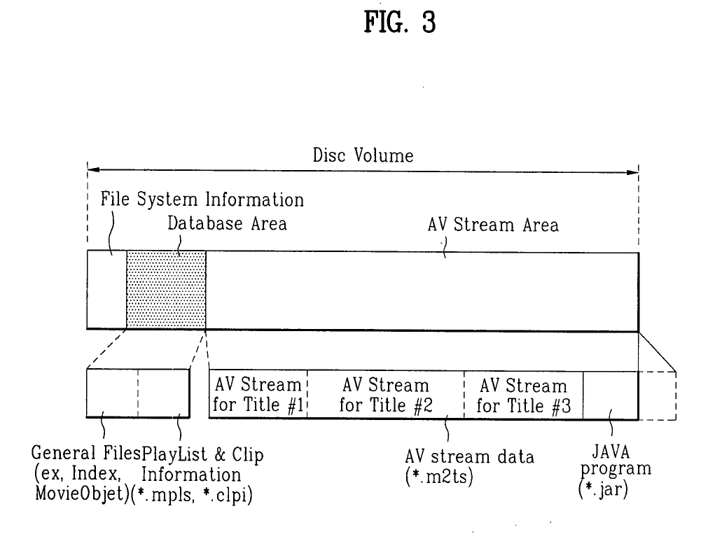

For realizing the requirement of the user, a file structure for interconnection between the original data and the additional data is required. The file structure used in the BD and a data recording structure will be described in detail with reference to FIGS. 2 and 3.

FIG. 2 is a view showing an embodiment of a file structure of data recorded in a recording medium according to the present invention, such as a BD-ROM. The file structure shown in FIG. 2 will hereinafter be described.

The file structure for managing reproduction according to the present invention includes one or more BDMV directories in a single root directory. The BD directory includes not only an index file “index.bdmv” acting as a general file (i.e., an upper file) capable of guaranteeing user interactivity, but also an object file “MovieObject.bdmv”. The file structure also includes a variety of directories for storing information of actual data recorded in a disc and other information associated with a method for reproducing the data, for example, a playlist directory (PLAYLIST), a clip-info directory (CLIPINF), a stream directory (STREAM), a BD-J object directory (BDJO) including a BD-J object file, and a Java directory (JAVA) including a JAR file. The file structure also includes an auxiliary directory (AUXDATA) including auxiliary data associated with reproduction of the disc. The above-mentioned directories and a variety of files included in the directories will hereinafter be described.

The stream directory (STREAM) includes a plurality of AV stream files recorded in the disc with a specific format. For example, the stream directory (STREAM) uses extension-names of stream files (01000.m2ts, . . . ) as a specific extension name “*.m2ts”. Generally, the stream file records moving image data as the contents related to the present invention.

The clip-info directory (CLIPINF) is composed of a plurality of clip information files (01000.clpi, . . . ) connected to the above-mentioned stream files on a one-to-one basis. Particularly, the clip information files (*.clpi) store attribute information and timing information of the stream files therein. The clip information files (*.clpi) connected to the stream files (*.m2ts) on a one-to-one basis are generically named a “Clip” in the BD standard. In other words, this indicates that a single stream file (*.m2ts) must correspond to a clip information file (*.clpi).

The clip information file includes program information on a sequence of source packets. The program is indicative of a set of program elements which are elementary streams, and the contents of the program in a single sequence are constant. The program information includes a packet identifier (PID) of a transport packet including a program map which may be applied by the program sequence, the number of elementary streams defined in the program sequence, a packet identifier of the elementary streams, and coding information of the elementary streams.

The playlist directory (PLAYLIST) includes a plurality of playlist files (00000.mpls, . . . ). Each playlist file (*.mpls) designates a playing interval during which a specific clip is reproduced such that the clip specifies the playing interval. The playing interval is also called playitem (PlayItem). Each playlist file (*.mpls) includes one or more playitems and may include one or more sub-playitems (SubPlayItems). Each of the playitem and the sub-playitem includes information on a reproduction start time (IN-Time) and a reproduction termination time (OUT-Time) of a specific clip to be reproduced. That is, the playlist file (*.mpls) is used as a basic reproduction management file unit contained in an overall file structure, such that it can reproduce a desired clip using a combination of one or more playitems.

The playlist file (*.mpls) is operated by only a command of a specific object of the above-mentioned object file. From the viewpoint of a disc reproduction scenario, the object executes or manages a dynamic scenario, and the playlist file (*.mpls) executes or manages a static scenario.

The playlist file includes playlist application information in which a parameter for reproduction control of the playlist is stored. The playlist application information may include reproduction type information of the playitems in the playlist, a user operation mask table indicating whether or not a user operation is allowed in a duration of the playlist, and a playlist random access flag indicating whether or not the optical recording/reproducing device can freely access the playlist and perform an operation such as jump or resumption of the user operation.

A process for reproducing data using one or more playitems in the playlist file is referred to as a main path, and a process for reproducing data using individual sub-playitems is referred to as a sub-path. The main path provides master presentation of the playlist and the sub-path provides auxiliary presentations associated with the master presentation. The playlist file must contain the main path. The playlist file may contain at least one sub-path according to the presence or absence of the sub-playitem as necessary. In conclusion, the playlist file is used as a basic reproduction management file unit contained in overall reproduction management file structures for reproducing a desired clip by combination of one or more playitems.

Each playitem includes a stream number (STN) table for defining a list of elementary streams which can be selected by the optical recording/reproducing device 10 during the presentation of the playitem and the sub-paths associated therewith. For the STN table of each playitem in the playlist, a content author determines which elementary streams of the sub-path and the main clip have entries in the STN table.

The STN table includes a primary video stream number, primary audio stream number, a presentation graphic/text subtitle (PG textST) stream number, an interactive graphic (IG) stream number, a secondary audio stream number, a secondary video stream number and a Picture-in-Picture (PiP) PG textST stream number. A stream entry (stream_entry) of each stream number and a stream attribute (stream_attribute) of coding association information on the elementary stream corresponding to the stream number are listed in the STN table.

The primary video is provided to a primary video decoder as a video stream for a main video program and the secondary video is provided to a secondary video decoder as a video stream for the PiP. The term “PiP” is indicative of a function for presenting the second video to the primary video by the optical recording/reproducing device 10. The PG textST is indicative of a presentation graphic or a text subtitle displayed in the main video program and the PiP PG textST is indicative of a presentation graphic or a text subtitle for the PiP. The IG is indicative of a stream including information for providing a series of interactive displays. The primary audio is an audio stream having a high bit-rate for the main audio program and the secondary audio is an auxiliary audio stream mixed with the primary audio stream.

The BDMV directory includes the BDJO directory (BDJO) including the BD-J object file for reproducing the BD-J title.

The Java directory (JAR) in the BDMV directory records a plurality of Java archive (JAR) files (e.g., PPPPP.jar, . . . ) therein. A variety of applications are programmed in individual JAR files. The JAR file is a compression file used for distributing a group including a plurality of files, and Java classes associated with a specific Java program, auxiliary resources and metadata are stored in the JAR file.

The auxiliary directory (AUXDATA) includes files including auxiliary information associated with reproduction of the disc and may include a sound file “sound.bdmv” for providing an interactive audio, such as click sound and menu sound information upon reproduction, and a font file “11111.otf” for providing font information upon reproduction of the text subtitle.

The metadata directory (META) includes the metadata. The metadata is data about data and includes a search file or a disc library file.

The positions of the above-mentioned files and directories are only exemplary and may be changed as necessary. For example, a sub-directory including the BDJO directory (BDJO) and the Java directory (JAR) may be separately included in the root directory or the Java directory may be included in the root directory as an upper-level directory.

FIG. 3 is a view showing a data recording structure recorded in an optical disc, which shows a recording form of the information associated with the above-mentioned file structure in the disc.

It can be seen that, from an inner circumference of the disc, there is a file system information area acting as system information for managing all the files, an area (also, referred to as a “database area”) for recording an index file, an object file, a playlist file, and a clip information file to reproduce a recorded stream (*.m2ts), and a stream area or data area for recording a plurality of streams composed of audio data, video data, and graphic data, etc. or a JAR file.

A predetermined area for recording file information for reproducing contents in the data area is called a management area, and corresponds to the file system information area and the database area. It should be noted that individual areas shown in FIG. 3 have been provided to describe an example, and the present invention is not limited to an arrangement structure of the above-mentioned areas shown in FIG. 3.

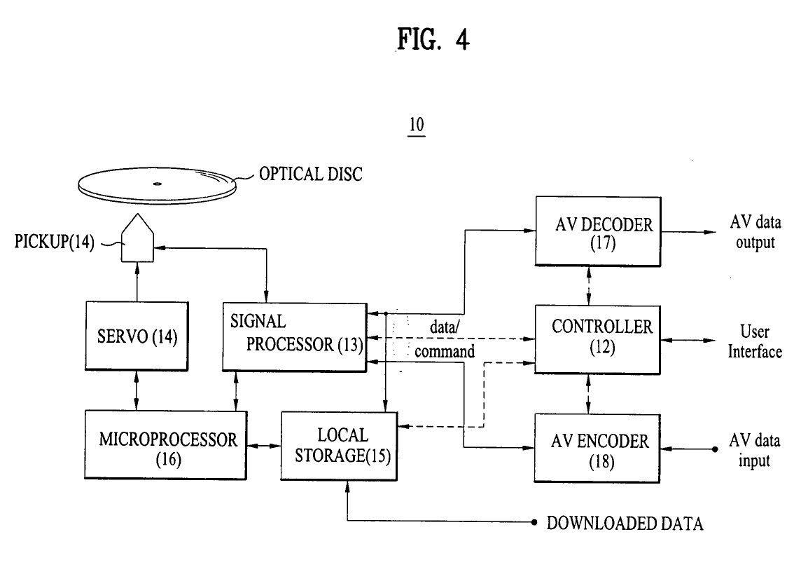

FIG. 4 is a view showing the configuration of an embodiment of the optical recording/reproducing device 10 according to the present invention.

The optical recording/reproducing device 10 includes a pickup unit 11 for reading original data recorded in the optical disc and reproduction management information including file information, a servo unit 14 for controlling operations of the pickup unit 11, a signal processor 13 for receiving a reproduction signal from the pickup unit 11, restoring the received reproduction signal to a desired signal value, or modulating a signal to be recorded into another signal recorded in the optical disc such that it transmits the recovered or modulated result, and a microprocessor 16 for controlling overall operations of the above-mentioned components contained in the optical recording/reproducing device 10.

The combination of the pickup unit 11, the servo unit 14, the signal processor 13 and the microprocessor 16 is also called a recording/reproducing unit. From the viewpoint of reproduction, the recording/reproducing unit reads data from the optical disc 30 or a local storage 15 and provides the data to an AV decoder 17b under the control of a controller 12. That is, the recording/reproducing unit acts as the reproducing unit (reading unit) for reading the data from the viewpoint of the reproduction. The recording/reproducing unit acts as a recording unit for receiving a signal encoded by an AV encoder 18 and recording a clip AV stream and management information on the clip AV stream in the optical disc 30.

The controller 12 downloads additional data recorded on the outside of the optical disc by a user command, stores the additional data in the local storage 15, generates a virtual package so as to reproduce data recorded in the recording medium and the data recorded in the local storage, and reproduces the original data and/or the additional data using the generated virtual package according to the requirement of the user.

The virtual package is generated by a binding operation performed by a virtual file system and is used as a file structure for managing the reproduction of an original clip composed of the original data in the disc and an additional clip composed of the additional data in the local storage, which are respectively stored in different areas.

The controller 12 and the microprocessor 16 are separately operated. Alternatively, the functions of the controller 12 and the microprocessor 16 may be combined and operated as a single unit. The controller 12 may be implemented by a program (software) and/or hardware included in the optical recording/reproducing device 10.

In the present invention, the control unit 12 generates management information of a clip AV stream including information indicating whether audio mixing is applied to the primary audio stream and controls the recording unit to record the management information in the recording medium.

The AV decoder 17 finally decodes an AV signal read from the recording medium and/or the local storage 15 upon receiving a control signal from the controller 12 and provides the decoded result to the user. The AV decoder 17 may include a plurality of decoders according to the type of the signal.

The AV encoder 18 converts an input signal into a specific format signal (e.g., an MPEG2 transport-stream) upon receiving a control signal from the controller 12, and transmits the converted result to the signal processor 13, such that it can record a desired signal in the optical disc.

The present invention relates to reproduction of audio data associated with the recording medium. The audio data may include primary audio data, secondary audio data and/or interactive audio data. In the present invention, a method for controlling mixing between audio data and controlling a scheme for presenting the audio data is provided.

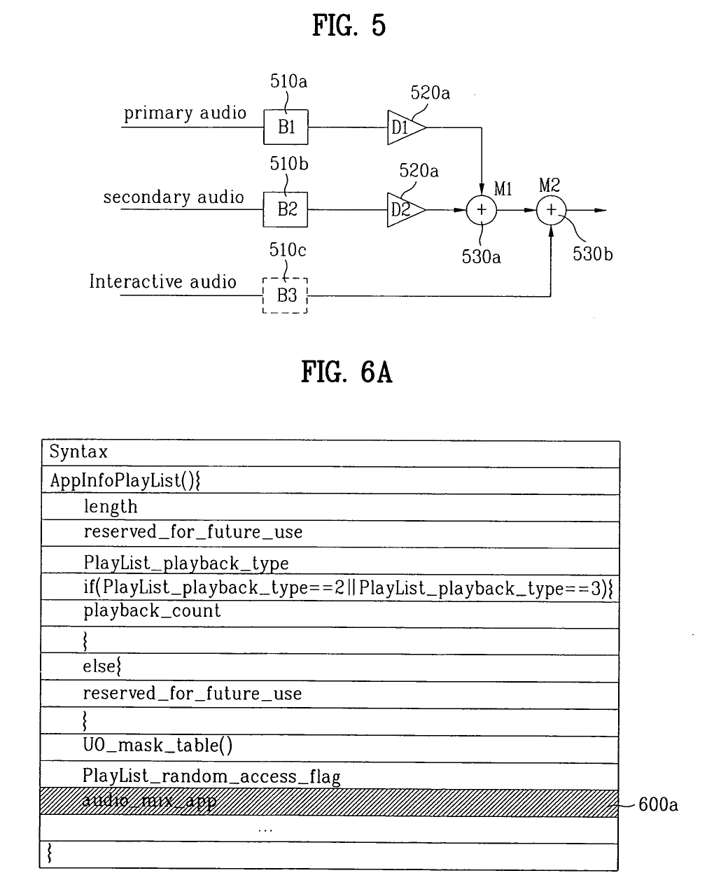

FIG. 5 is a conceptual view showing an audio mixing model for better understanding audio mixing according to the present invention.

The audio mixing indicates that the primary audio stream is mixed with the secondary audio stream and/or the interactive audio. Hereinafter, mixing of the primary audio stream with the secondary audio stream is called secondary audio mixing and mixing of the primary audio stream with the interactive audio is called interactive audio mixing.

The audio mixing model according to the present invention mixes the primary audio stream with the secondary audio stream and/or the interactive audio using mixing coefficients. In order to perform decoding and mixing, the model includes two audio decoders D1 and D2 and two audio mixers M1 and M2. A content provider controls an audio mixing process using audio mixing control parameters.

The primary audio which is an audio stream for the main video program is generally a movie sound track included in the recording medium. However, the primary audio may be downloaded from a network and stored in the local storage 15. The AV stream in which the primary audio stream is multiplexed in the recording medium and/or local storage is read by the reproducing unit and provided to a PID filter. The AV stream is sorted in the PID filter according to a PID and necessary transport packets of a transport stream are output and provided to an audio decoder (D1) 520a via a first buffer (B1) 510a. The primary audio stream is decoded in the primary audio decoder 520a using linear pulse code modulation (hereinafter, LPCM).

The secondary audio is auxiliary audio mixed with the primary audio. The secondary audio is an auxiliary audio stream or a director's comment designed to be mixed with the primary audio stream. The secondary audio is generally stored in the local storage 15 of the optical recording/reproducing device and may be recorded in the recording medium. A necessary transport stream is selected from the secondary audio by the PID filter and provided to the secondary audio decoder (D2) 520b via a second buffer (B2) 510b. The secondary audio decoder 520b decodes the provided secondary audio stream using LPCM. In addition, mixing metadata included in the secondary audio stream may be extracted. The mixing metadata is converted into a mixing matrix and used in a mixing process.

Each channel output decoded by the secondary audio decoder 520b may be provided to the audio mixer (M1) 530a and mixed with at least one channel output decoded by the primary audio decoder 520a.

The result output from the audio mixer (M1) 530a may be provided to the secondary audio mixer (M2) 530b and mixed with the interactive audio. The interactive audio is an LPCM audio activated by an application and may be mixed with the primary audio in the audio mixer (M2) 530b via a third buffer (B3) 510c. The interactive audio may be mixed with the primary audio unmixed with the secondary audio. For example, when the secondary audio is provided as a portion of audio effect, the interactive audio is mixed with the primary audio mixed with the secondary audio. The interactive audio may be stored in the local storage 15 or the recording medium and generally used for providing dynamic sound associated with an interactive application such as button sound.

The result output from the audio mixer (M2) 530b is converted into an analog signal by an analog output unit or provided to an external digital analog converter (DAC) via a digital output unit in a digital format and converted into an analog signal by the digital analog converter (DAC).

In the present invention, in the mixing process, since the primary audio passes through modules of the audio mixing model, the original data is distorted and thus audio quality deteriorates and noise occurs. However, audiophiles or audio experts may require reproduction of the primary audio unmixed with the secondary audio and/or the interactive audio such that the distortion of the original data is reduced as much as possible. In the present invention, in order to satisfy the requirement of the user, a mixing indicator indicating whether the mixing is applied is included in management information for managing reproduction of the audio data. When the content provider allows the user to listen to an unmixed audio, the content provider may set the information to indicate that the mixing is not applied to the provided audio data in the management information of the audio data. Generally, the management information is stored in a database file such as a playlist file or a clip information file and provided to the optical recording/reproducing device 10.

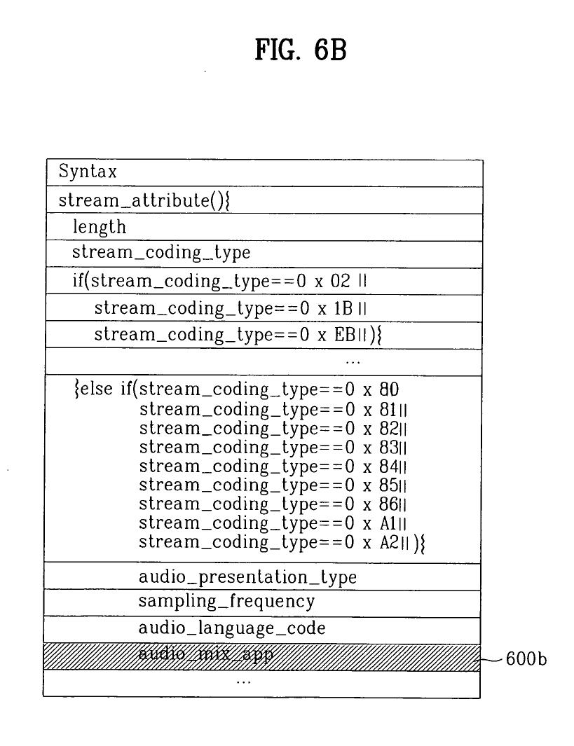

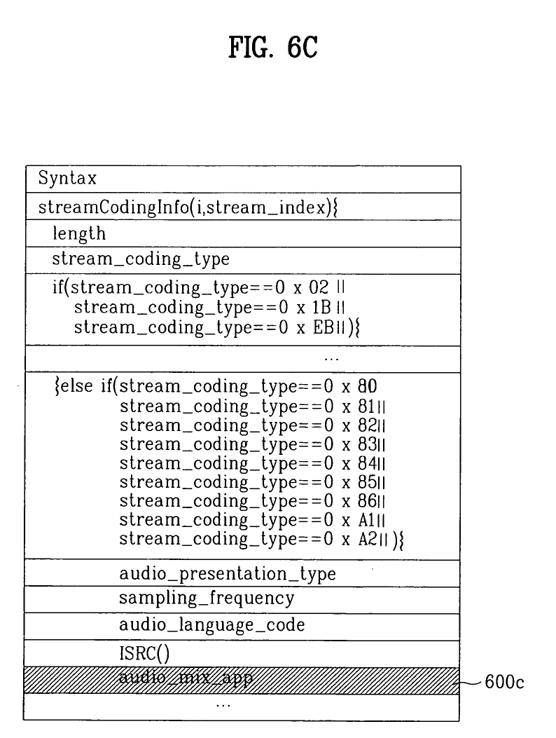

FIGS. 6a to 6c are views showing embodiments of management information including an audio mixing indicator according to the present invention.

FIG. 6a shows a case where the audio mixing indicator is included in playlist application information (AppInfoPlayList) in a playlist file, FIG. 6b shows a case where the audio mixing indicator is included in stream attribute information in the playlist file, and FIG. 6c shows a case where the audio mixing indicator is included in stream coding information (StreamCodingInfo) in a clip information file.

Referring to FIG. 6a, the content provider may set the audio mixing indicator 600a indicating whether the secondary audio mixing or the interactive audio mixing is applied to the playlist file. FIG. 6a shows the case where the mixing indicator is included in the playlist application information, in which parameters for controlling the reproduction of the playlist are stored.

For example, the controller 12 checks the mixing indicator and does not apply the audio mixing to the playlist when the mixing indicator is set to “0”. As a result, the reproduced primary audio stream is not mixed with the secondary audio and the interactive audio on the basis of the playlist. Accordingly, in case that the mixing indicator is set to “0”, the secondary audio stream entry may not be defined in the STN table of the playlist. Besides, in case that the playlist uses interactive graphic streams, the sound data in the sound file “sound.bdmv”, which is selected or activated by the interactive graphic streams, may not be specified. In case that an application using a Java platform uses the playlist, the application does not use applications for performing the interactive audio mixing.

When the optical recording/reproducing device 10 according to the present invention includes a digital output unit, the unmixed audio stream is converted into a digital transmission signal by the digital output unit and the digital transmission signal is supplied to a digital analog converter (DAC). Since a general sound card internally processes digital data, the digital data must be converted into an analog data upon output process. In this case, the DAC embedded in the sound card is used. However, since most digital/analog performance of a sound card processor is not suitable for audiophiles or audio experts, sound quality may deteriorate or noise may occur. The digital output unit outputs the digital data output from a sound source to an external high-quality digital analog converter such that the original audio data is not distorted in digital apparatuses and unnecessary noise is reduced as much as possible. The digital output unit acts as a digital interface used in the interconnection among the digital audio apparatuses.

In contrast, when the mixing indicator is set to “1”, the controller 12 may apply the secondary audio mixing and/or the interactive audio mixing to the playlist. That is, the primary audio to be reproduced on the basis of the playlist may be mixed with the secondary audio and/or the interactive audio.

In case that the secondary and/or interactive audio mixing is applied, the mixed audio is output to the analog output unit or the digital output unit. The digital output unit receives and processes the non-decoded data format. Accordingly, in case that audio data is mixed, the mixed audio is encoded to a signal which can be processed by the digital output unit and the encoded result is supplied to the digital output unit.

FIG. 6b shows another embodiment of the present invention, in which the mixing indicator is included in the stream attribute information of a corresponding stream. The stream attribute information may be included in the STN table of the playitem in the playlist for managing the reproduction of the stream. While it is defined whether the mixing is applied to the overall audio stream managed by the playlist in the embodiment shown in FIG. 6a, it is defined whether the mixing is applied to each stream in the embodiment shown in FIG. 6b.

A stream coding type indicates a coding type of the elementary stream associated with the stream number corresponding to the stream attribute. For example, a elementary stream having a stream coding type of “0x02” indicates an MPEG-2 video stream for the primary/secondary video, a elementary stream having “0x1B” indicates an MPEG-4 video stream for the primary/secondary video, and a elementary stream having “0xEB” indicates an “SMPTE VC-1” video stream for the primary/secondary video. A elementary stream having a stream coding type of “0x80” indicates a “HDMV LPCM” audio stream for the primary audio, a elementary stream having “0x81” indicates a Dolby digital (AC-3) audio stream for the primary audio, a elementary stream having “0x82” indicates a “decoding time stamp (DTS)” audio stream for the primary audio, a elementary stream having “0x83” indicates a Dolby lossless audio stream for the primary audio, a elementary stream having “0x84” indicates a Dolby digital plus stream for the primary audio, a elementary stream having “0x85” indicates a DTS-HD audio stream except XXL for the primary audio, a elementary stream having “0x86” indicates a DTS-HD audio stream for the primary audio, a elementary stream having “0xA1” indicates a Dolby digital plus audio stream for the secondary audio, and a elementary stream having “0xA2” indicates a DTS-HD audio stream for the secondary audio.

Referring to FIG. 6b, when the stream coding type indicates one of the audio stream types, the mixing indicator, indicating whether the audio mixing is applied to the audio stream corresponding to the stream attribute information, is set (600b). For example, when the mixing indicator is set to “0”, the controller 12 controls the audio mixing not to be applied to the corresponding audio stream and the audio stream to bypass the audio mixers 530a and 530b. As a result, the primary audio stream is not mixed with the secondary audio and/or the interactive audio. In contrast, when the mixing indicator is set to “1”, the controller 12 may control the secondary audio mixing and/or the interactive audio mixing to be applied to the primary audio stream. That is, the primary audio may be mixed with the secondary audio and/or the interactive audio.

The stream attribute information of the audio stream may include presentation type information (“audio_presentation_type”) of the audio stream associated with the stream number for the stream attribute, information (“sampling_frequency”) indicating a sampling frequency of the audio stream and information (“audio_language_code”) indicating a language code of the audio stream.

FIG. 6c shows another embodiment of the present invention, in which the mixing indicator is included in the clip information file. The embodiment shown in FIG. 6c is different from those shown in FIGS. 6a and 6b in that the mixing indicator is included in the clip information file, not in the playlist file.

Referring to FIG. 6c, the clip information file may include program information (ProgramInfo) which is information on a program sequence (program-sequence), and the program information may include stream coding information (StreamCodingInfo). The mixing indicator according to the present invention defines the stream coding type of the audio stream (600c). The controller 12 checks the clip information file and determines whether the mixing is applied to the audio stream specified by the clip information file. In the embodiment shown in FIG. 6c, it can be determined whether the mixing is applied to each stream, similar to the embodiment shown in FIG. 6b.

In the clip information file, stream coding information on an audio stream may include presentation type information of the audio stream, information indicating a sampling frequency of the audio stream, and information indicating a language code of the audio stream described in FIG. 6b. An international standard recording code (ISRC) including a country code, a copyrighter, a recording year and a recording number may be included as the stream coding information.

The mixing information according to the present invention may be included in any one of the playlist program information, the stream attribute information or the stream coding information or both the stream attribute information and the stream coding information.

The management information of the audio data such as the playlist file and the clip information file may be downloaded over a network. In this case, the content provider may include the mixing indicator according to the present invention in the downloaded management information and provide the management information including the mixing indicator to the user.

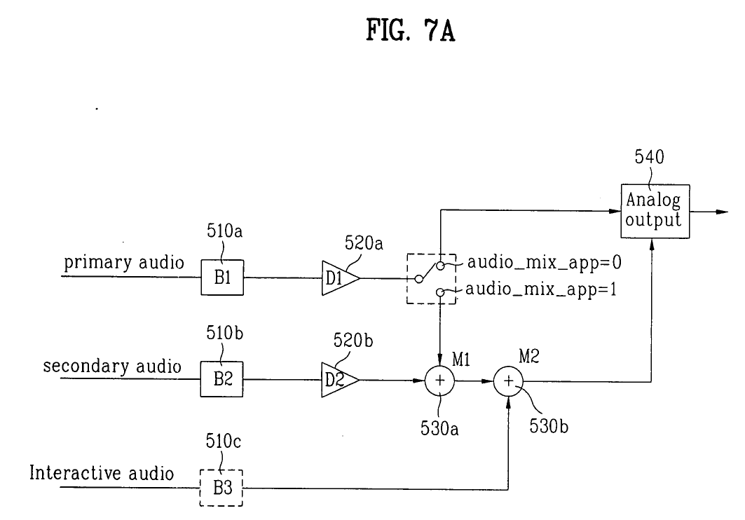

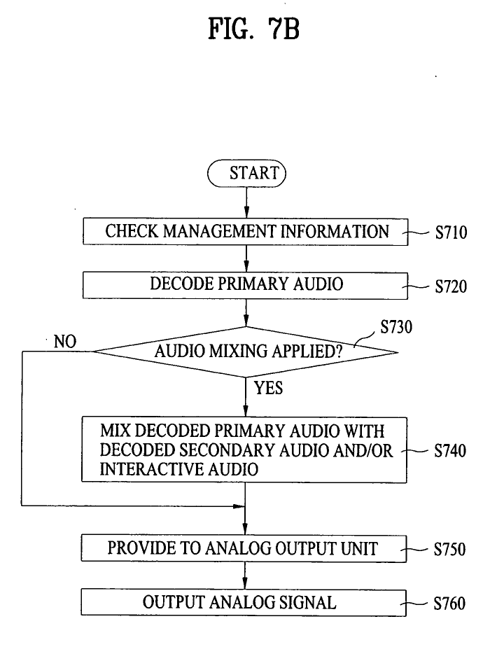

FIGS. 7a and 7b are views showing an embodiment of reproduction of audio data according to the present invention, which shows a method for processing and reproducing audio data in the audio mixing model.

The optical recording/reproducing device 10 according to the present invention reads and checks the management information on the data to be reproduced from the recording medium and/or the local storage 15 so as to reproduce the data recorded in the recoding medium (S710). The AV stream recorded in the recording medium and/or the local storage 15 is reproduced on the basis of the management information.

The AV stream to be reproduced is read from the recording medium and/or the local storage 15, sorted by the PID filter according to the PID, and supplied to a corresponding decoder included in the AV decoder 17. The transport packets which have packet identifier of the primary audio and carry the primary audio stream are supplied to and encoded by the primary audio decoder 520a (S720). When the clip AV stream includes the secondary audio stream, the transport packets which have the packet identifier of the secondary audio and carry the secondary audio stream are supplied to and decoded by the secondary audio decoder 520b.

The controller 12 according to the present invention controls an output path of the primary audio on the basis of the audio mixing information. For example, when it is determined that the audio mixing is not applied on the basis of the mixing indicator (audio_mix_app=0) (S730), the controller 12 provides the decoded primary audio to the analog output unit 540 without passing via the audio mixer (S750).

In contrast, when it is determined that the audio mixing is applied on the basis of the mixing indicator (audio_mix_app=1) (S730), the controller 12 provides the decoded primary audio to the audio mixers 530a and 530b. In the audio mixers, the decoded primary audio is mixed with the secondary audio decoded by the secondary audio decoder 520b and/or the interactive audio (S740). The primary audio mixed with the secondary audio and/or the interactive audio is provided to the analog output unit 540 (S750) and converted into the analog signal in the analog output unit 540, and the converted signal is output via a speaker (S760).

In the optical recording/reproducing device 10 according to the present invention, the user may determine to bypass the mixers 540a and 540b. In this case, the unmixed audio data is output.

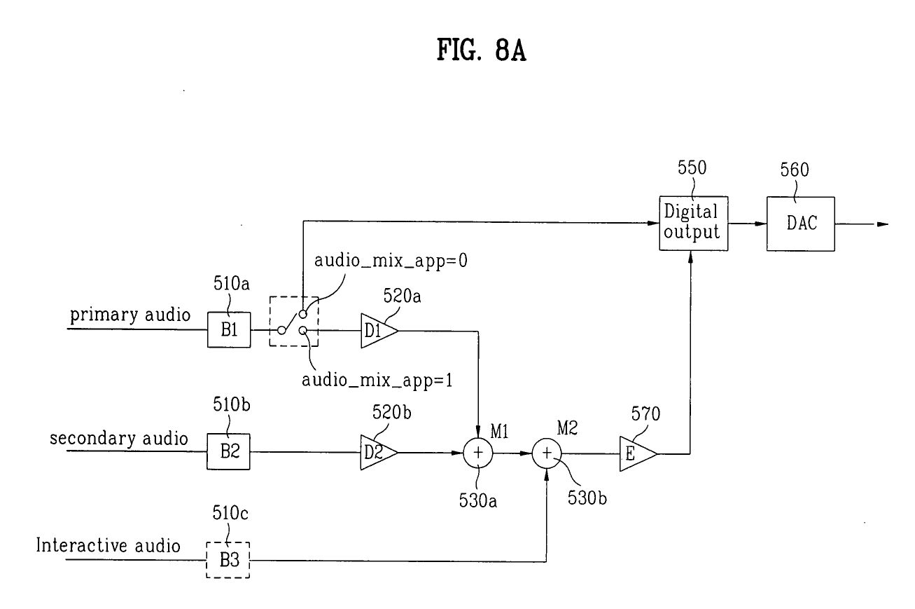

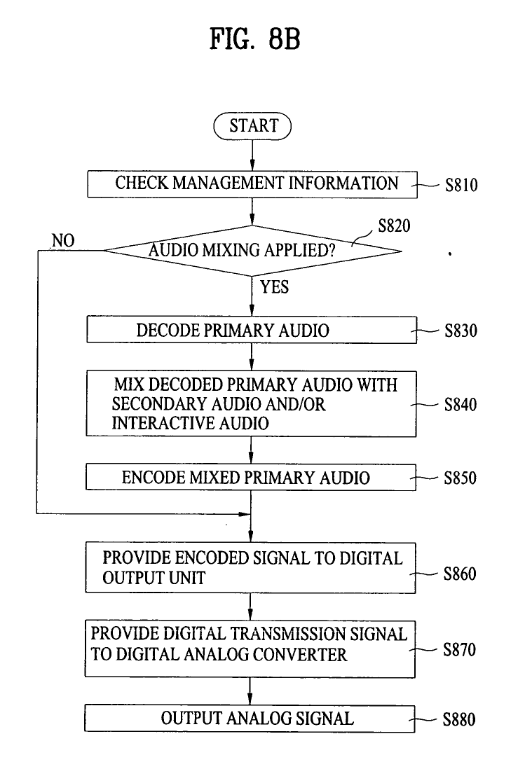

FIGS. 8a and 8b are views showing another embodiment of reproduction of audio data according to the present invention, which shows a method for processing and reproducing audio data in the audio mixing model when the optical recording/reproducing device 10 includes a digital output unit 550.

Referring to FIGS. 8a and 8b, the controller 10 checks the management information (S810) and determines whether the audio mixing is applied on the basis of the audio mixing indicator included in the management information (S820). When it is determined that the audio mixing is not applied on the basis of the mixing indicator (audio_mix_app=0) (S820), the controller 12 controls the primary audio read from the recording medium and/or the local storage 15 to be provided to the digital output unit 550 without passing via the primary audio decoder 520a and the audio mixers 530a and 530b (S860). The primary audio is converted into a digital transmission signal by the digital output unit 550 and the digital transmission signal is provided to an external DAC 560 (870). The digital transmission signal is converted into an analog signal by the DAC and the analog signal is output via a speaker (S880).

However, when it is determined that the audio mixing is applied on the basis of the mixing indicator (audio_mix_app=1) (S830), the controller 12 controls the primary audio to be decoded in the primary audio decoder 520a (S830) and to be provided to the audio mixers 530a and 530b. In the audio mixers, the decoded primary audio is mixed with the secondary audio and/or the interactive audio decoded in a secondary audio decoder 520b (S840).

The digital output unit 550 according to the present invention receives an audio stream having a bit-stream format and converts the audio stream into the digital transmission signal. Accordingly, when the audio stream is decoded into the LPCM data, the decoded audio stream must be encoded to a bit-stream which can be processed in the digital output unit 550. Accordingly, the mixed primary audio is encoded to the bit-stream by the encoder 570 (S850) and the encoded signal is provided to the digital output unit 550 (S860). In the encoder 570, the mixed audio may be encoded to a Dolby digital audio stream or DTS audio stream having the same or more number of channels (5.1 channel) as the primary audio stream.

The encoded audio is converted into the digital transmission signal in the digital output unit 550 (S860), the digital transmission signal is converted into the analog signal in the DAC 560 (S870), and the analog signal is output (S880).

The optical recording/reproducing device 10 according to the present invention may include a user selection option which allows the primary audio stream to bypass the mixing and the encoding. That is, the optical recording/reproducing device 10 may be set such that the primary audio stream bypasses the mixers 530a and 530b and the encoder 570, according to the selection of the user. In this case, although the mixing indicator is set to “1” such that the mixing is possible, the primary audio stream may be directly provided to the digital output unit 50 according to the selection of the user, similar to the case where the mixing indicator is set to “0”.

According to the present invention, the content provider can control whether a primary audio is mixed, using a mixing indicator. In case that the content provider wants to provide an audio close to an original audio to a user, the content provider sets the mixing indicator to “0” such that the primary audio is not mixed.

According to the present invention, the content provider can control whether audio data is mixed. Accordingly, the content provider can actively control reproduction of contents.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method of reproducing audio data, comprising:
checking a mixing indicator included in management information for managing reproduction of the audio data, the mixing indicator indicates whether mixing is applied to primary audio; and
controlling whether to mix the primary audio with secondary and/or interactive audio on the basis of the mixing indicator.

2. The method of claim 1, wherein the primary audio is not mixed with the secondary and/or interactive audio in case that the mixing indicator indicates that the mixing is not applied.

3. The method of claim 2, wherein the primary audio unmixed with the secondary and/or interactive audio is converted into a digital transmission signal by a digital output unit.

4. The method of claim 3, wherein the digital transmission signal is transmitted to a digital analog converter (DAC) and converted into an analog output signal by the digital analog converter (DAC).

5. The method of claim 1, wherein the primary audio is mixed with the secondary and/or interactive audio in case that the mixing indicator indicates that the mixing is applied.

6. The method of claim 5, wherein the primary audio mixed with the secondary and/or interactive audio is encoded, and the encoded primary audio is converted into a digital transmission signal by a digital output unit.

7. The method of claim 6, wherein the digital transmission signal is transmitted to a digital output unit and the digital transmission signal is converted into an analog output signal by a digital analog converter (DAC) included in the digital output unit.

8. The method of claim 6, wherein the encoded primary audio has the same or more number of channels as the primary audio.

9. The method of claim 1, wherein the controlling includes determining whether to mix the primary audio with the secondary and/or interactive audio in case that the indicator indicates that the mixing is applied.

10. An apparatus for reproducing audio data, comprising:
a mixer mixing primary audio with secondary and/or interactive audio; and
a control unit checking a mixing indicator included in management information for managing reproduction of the audio data and controlling whether to mix the primary audio with the secondary and/or interactive audio on the basis of the mixing indicator, the mixing indicator indicates whether mixing is applied to the primary audio.

11. The apparatus of claim 10, wherein the control unit controls the primary audio not to be mixed with the secondary and/or interactive audio in case that the mixing indicator indicates that the mixing is not applied.

12. The apparatus of claim 10, wherein the control unit controls the primary audio to be mixed with the secondary and/or interactive audio in case that the mixing indicator indicates that the mixing is applied.

13. The apparatus of claim 11, further comprising:
an encoder encoding the primary audio mixed with the secondary and/or interactive audio into an audio bit-stream.

14. The apparatus of claim 13, wherein the audio bit-stream has the same or more number of channels as the primary audio.

15. The apparatus of claim 10, further comprising:
a digital output unit converting an audio bit-stream into a digital transmission signal.

16. The apparatus of claim 10, further comprising:
a digital analog converter (DAC) converting a digital transmission signal into an analog output signal.

17. The apparatus of claim 10, wherein control unit determines whether to mix the primary audio with the secondary and/or interactive audio in case that the mixing indicator indicates that the mixing is applied, and controls the mixer on the basis of the determination.

18. A recording medium having audio data, comprising:
at least one stream file including primary audio; and
a mixing indicator indicating whether mixing is applied to the primary audio.

19. The recording medium of claim 18, wherein the mixing indicator indicates that the primary audio is not mixed with secondary and/or interactive audio, or indicates that the primary audio is capable of being mixed with the secondary and/or interactive audio.

20. The recording medium of claim 18, wherein the mixing indicator is included in a playlist file for managing reproduction of the stream file.

21. The recording medium of claim 20, wherein the mixing indicator indicates whether the mixing is applied to the playlist file.

22. The recording medium of claim 20, wherein the mixing indicator is included in the playlist file as stream attribute information.

23. The recording medium of claim 18, wherein the mixing indicator is included in a clip information file corresponding to the stream file.

24. A method of recording audio data on a recording medium, comprising:
recording at least one stream file including primary audio and management information for managing reproduction of the stream file on the recording medium,
wherein the management information includes a mixing indicator indicating whether mixing is applied to the primary audio.

25. The method of claim 24, wherein the management information including the mixing indicator is a playlist file for managing reproduction of the stream file.

26. The method of claim 24, wherein the management information including the mixing indicator is a clip information file corresponding to the stream file.

27. An apparatus for recording audio data on a recording medium, comprising:
a recording unit recording data on the recording medium; and
a control unit controlling the recording unit to record at least one stream file including primary audio and management information for managing reproduction of the stream file on the recording medium,
wherein the management information includes a mixing indicator indicating whether mixing is applied to the primary audio.

28. The apparatus of claim 27, wherein the management information including the mixing indicator is a playlist file for managing reproduction of the stream file.

29. The apparatus of claim 27, wherein the management information including the mixing indicator is a clip information file corresponding to the stream file.

30. A method of creating a data structure managing reproduction of audio data, comprising:
creating at least one stream file including primary audio; and
creating at least one management file for managing reproduction of the stream file,
wherein the management file includes a mixing indicator indicating whether mixing is applied to the primary audio.

31. The method of claim 30, wherein the management file is a playlist file for managing reproduction of the stream file.

32. The method of claim 30, wherein the management file is a clip information file corresponding to the stream file.

33. An apparatus for creating a data structure managing reproduction of audio data, comprising:
a control unit creating at least one stream file including primary audio and creating at least one management file for managing reproduction of the stream file,
wherein the management file includes a mixing indicator indicating whether mixing is applied to the primary audio.

34. The apparatus of claim 33, wherein the management file is a playlist file for managing reproduction of the stream file.

35. The apparatus of claim 30, wherein the management file is a clip information file corresponding to the stream file.

36. A method of reproducing audio data associated with a recording medium, comprising:
downloading at least one management file associated with the recording medium, the management file manages reproduction of at least one stream file including primary audio;
creating virtual package including the stream file and the downloaded management file;
checking a mixing indicator included in the downloaded management file, the mixing indicator indicates whether mixing is applied to the primary audio; and
controlling whether to mix the primary audio with secondary and/or interactive audio on the basis of the mixing indicator.

37. The method of claim 36, wherein the primary audio is not mixed with the secondary and/or interactive audio in case that the mixing indicator indicates that the mixing is not applied, and mixed with the secondary and/or interactive audio in case that the mixing indicator indicates that the mixing is applied.

38. The method of claim 37, wherein the primary audio unmixed with the secondary and/or interactive audio is converted into a digital transmission signal by a digital output unit.

40. The method of claim 37, wherein the primary audio mixed with the secondary and/or interactive audio is encoded, and the encoded primary audio is converted into a digital transmission signal by a digital output unit.

41. The method of claim 37, wherein the management file is a playlist file for managing reproduction of the stream file.

42. The method of claim 37, wherein the management file is a clip information file corresponding to the stream file.

43. An apparatus for reproducing audio data associated with a recording medium, comprising:
a storage unit storing downloaded data associated with the recording medium;
a control unit downloading at least one management file associated with the recording medium to the storage unit, the management file manages reproduction of at least one stream file including primary audio, the control unit creating virtual package including the stream file and the downloaded management file, the control unit checking a mixing indicator included in the downloaded management file, the mixing indicator indicates whether mixing is applied to the primary audio, and the control unit controlling whether to mix the primary audio with secondary and/or interactive audio on the basis of the mixing indicator.

44. The apparatus of claim 43, wherein the controlling unit controls the primary audio not to be mixed with the secondary and/or interactive audio in case that the mixing indicator indicates that the mixing is not applied, or controls the primary audio to be mixed with the secondary and/or interactive audio in case that the mixing indicator indicates that the mixing is applied.

45. The apparatus of claim 44, further comprising:
an encoder encoding the primary audio mixed with the secondary and/or interactive audio into an audio bit-stream.

46. The apparatus of claim 43, further comprising:
a digital output unit converting an audio bit-stream into a digital transmission signal.

47. The apparatus of claim 43, further comprising:
a digital analog converter (DAC) converting a digital transmission signal into an analog output signal.

48. A method of reproducing audio data, comprising:
checking a mixer bypass indicator included in management information for managing reproduction of the audio data, the mixer bypass indictor indicates whether a mixer for secondary and/or interactive audio is bypassed, and
controlling whether to bypass the mixer on the basis of the mixer bypass indicator.

49. A recording medium having audio data, comprising:
at least one stream file including primary audio; and
at least one management file for managing reproduction of the stream file, the management file includes a mixer bypass indicator indicating whether a mixer for secondary and/or interactive audio is bypassed.
